(19) United States
(12) Patent Application Publication
(10) Pub. No.: US 2023/0223648 A1
(43) Pub. Date: Jul. 13, 2023

(54) BATTERY FOR ELECTRIC VEHICLE

(71) Applicant: VOLTABOX, Delbrûck (DE)

(72) Inventors: Juergen PAMPEL, Vlotho (DE); Constantin WERTH, Paderborn (DE); Patrick ZABEL, Salzkotten (DE); Martin HELMES, Delbrueck (DE)

(21) Appl. No.: 18/022,371

(22) PCT Filed: Nov. 27, 2020
(86) PCT No.: PCT/EP2020/000204

§ 371 Date: Feb. 21, 2023

(30) Foreign Application Priority Data
Aug. 27, 2020 (DE) 102020002252.5

(51) Int. Cl. H01M 50/383; H01M 50/213; H01M 50/209; H01M 50/211; H01M 50/227; H01M 50/271; H01M 50/296; H01M 50/264; B60L 50/64

(52) U.S. Cl. CPC H01M 50/383; H01M 50/213; H01M 50/209; H01M 50/211; H01M 50/227; H01M 50/271; H01M 50/296; H01M 50/264; B60L 50/64; H01M 2220/20; B60L 58/26

(57) ABSTRACT

The invention relates to an electric battery (1) for a motor vehicle which is electrically or partly electrically driven or a movable or stationary unit, having a battery housing (5) and a plurality of battery cells (2) arranged therein. The aim of the invention is to allow such an electric battery (1) to be produced with minimal costs and technical structural complexity while still having a high degree of operational reliability. This is achieved in that the battery housing (5) is made of an expanded or foamed plastic.

The invention relates to an electric battery for an electrically or partially electrically driven motor vehicle or a movable or stationary unit, comprising a battery housing and a plurality of battery cells therein.

In order to be able to make an electric battery of this type that usually forms a core component of an electrically or partially electrically driven motor vehicle or of a movable unit, and which can be an essential part of a stationary unit, with as little economic and technically structural effort as possible, it is proposed according to the invention that the battery housing of the electric battery is made or formed of an expanded or foamed plastic. The electrical interconnection of the battery cells can take place before or after the introduction of the battery cells into the battery housing. Due to its design of the expanded or foamed plastic, the battery housing, compared to battery housings of this type that are known from the prior art, is suitable to absorb significantly higher mechanical energy amounts. Due to the design according to the invention of the battery housing of the expanded or foamed plastic, the assembly of the electric battery is furthermore significantly simplified. The production of the battery housing and thus of the electric battery can be automated to a large extent, whereby the economic effort can be reduced significantly. The material properties of the expanded or foamed plastic, ensure a thermal insulation of the electric battery in particular in cold environments. In the event of a so-called thermal runaway, the electric battery designed according to the invention ensures a high safety due to the slight resistance of the battery housing. Possible pressure build-up can be released directly into the environment. The electric battery can be assembled quasi in any installation position. Due to its absorbability for static and dynamic loads, the battery housing designed according to the invention ensures a high resistance against impacts, shocks, and vibrations.

The battery cells of the electric battery according to the invention can have any shapes; they can be formed, e.g., as round cell, as prismatic cell, or as pouch cell.

Instead of the battery housing or in addition to the battery housing, a holder can be provided for the battery cells and further battery components, e.g. sensor parts that is likewise made of the expanded or foamed plastic.

The battery housing as well as the holder that is optionally provided instead of the battery housing or in addition to the battery housing, can be of multi-piece construction.

Towards the top side, the battery housing can advantageously be closed by a cover that is likewise made of the expanded or foamed plastic.

The plus and minus poles of the battery cells are expediently guided to the outer side of the battery housing.

The same applies for further electrical interfaces, electronic interfaces, mechanical interfaces and/or thermal interfaces.

According to an advantageous design of the electric battery according to the invention, the battery housing thereof is made of plastic that is foamed onto a battery cell structure formed of the plurality of the battery cells of the electric battery, and that is cured there.

The battery cell structure that is formed of the battery cells, is advantageously joined together or fixed, by a belt surrounding the battery cells, before it is introduced into the battery housing or before the battery housing is made of the plastic around the battery cell structure.

Alternatively, it is possible to join together the battery cells to form the battery cell structure by their electric cell connectors that serve for the electrical connection to each other.

Each temporary fixing device can generally be provided in order to fix the battery cell structure.

Passages that can serve, e.g., as cooling, stiffening and/or reinforcing passages, can be provided in the entire body forming the battery housing.

When the battery housing of the electric battery has shapes formed on its outer side, by which a number of electric batteries of this type or battery housings, can be joined together or stacked, electric batteries of this type can be joined together in a simple way to form larger battery assemblies.

To ensure battery assemblies of this type that have a plurality of electric batteries, it is advantageous when the battery housings have latching means on their outer sides, by which a plurality of electric batteries of this type or battery housings, can be latched with one another or to one another.

When the foamed plastic forming the battery housing has a high gas content, the battery housing can be designed in extreme lightweight construction.

According to an advantageous embodiment of the electric battery according to the invention, the foamed plastic of the battery housing contains a flame-retardant, preferably self-extinguishing material. The battery housing advantageously has at least one reservoir or at least one cavity, in which extinguishing substances, e.g. PyroBubbles, can be stored. An increased safety can be provided thereby, whereby the dampening effect of the battery housing can furthermore be increased.

As further safety measure, it is possible to surround the battery housing or battery cell structure of the electric battery with a safety shell, wherein safety elements can furthermore be introduced into one or several cavities that are formed by the battery housing or battery cell structure.

Depending on the requirement profile, the battery housing can be designed arbitrarily with respect to its geometry, its outer surface, and its dimensions.

In the case of a method according to the invention for making and assembling an electric battery for an electrically or partially electrically driven motor vehicle, movable or stationary unit, a plurality of battery cells is in a battery housing, wherein the battery housing made of plastic is foamed onto a battery cell structure and is cured there.

During the foaming and curing of the battery cell housing, the battery cell structure can advantageously be fixed by a belt that surrounds this battery cell structure.

Alternatively, the battery cell structure can be fixed by electric cell connectors during the foaming and curing of the battery housing.

Alternatively or additionally, a temporary fixing device for the purpose of fixing the battery cell structure can be provided during the foaming and curing of the battery housing.

It is generally also possible to arrange the battery cell structure in fixed form in an installation space of the motor vehicle or of the unit, and to provide it with the battery housing there.

The invention will be described in more detail below on the basis of embodiments with reference to the drawing, in which:

FIG. 1 shows a perspective illustration of a group of battery cells of an embodiment of an electric battery according to the invention;

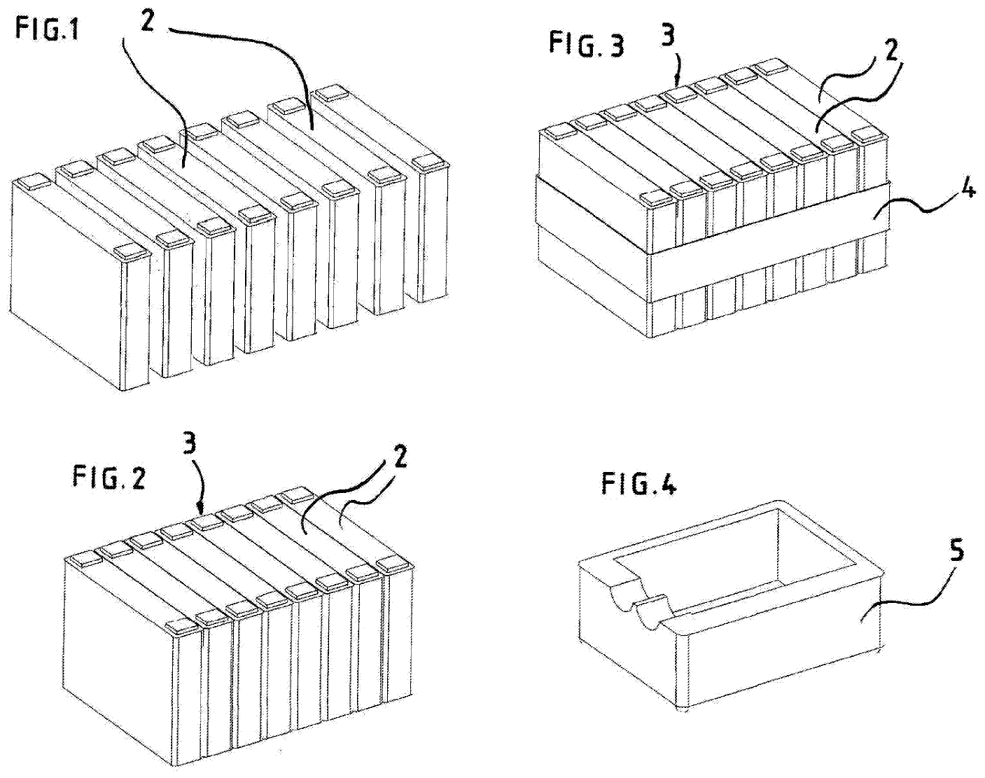

FIG. 2 shows a perspective illustration of a battery cell structure made up of the battery cells shown in FIG. 1;

FIG. 3 shows the battery cell structure shown in FIG. 2 comprising a belt surrounding it;

FIG. 4 shows a perspective illustration of a battery housing of the electric battery according to the invention;

FIG. 5 shows the battery housing shown in FIG. 4, in which the battery cell structure shown in FIG. 2 or 3, is received;

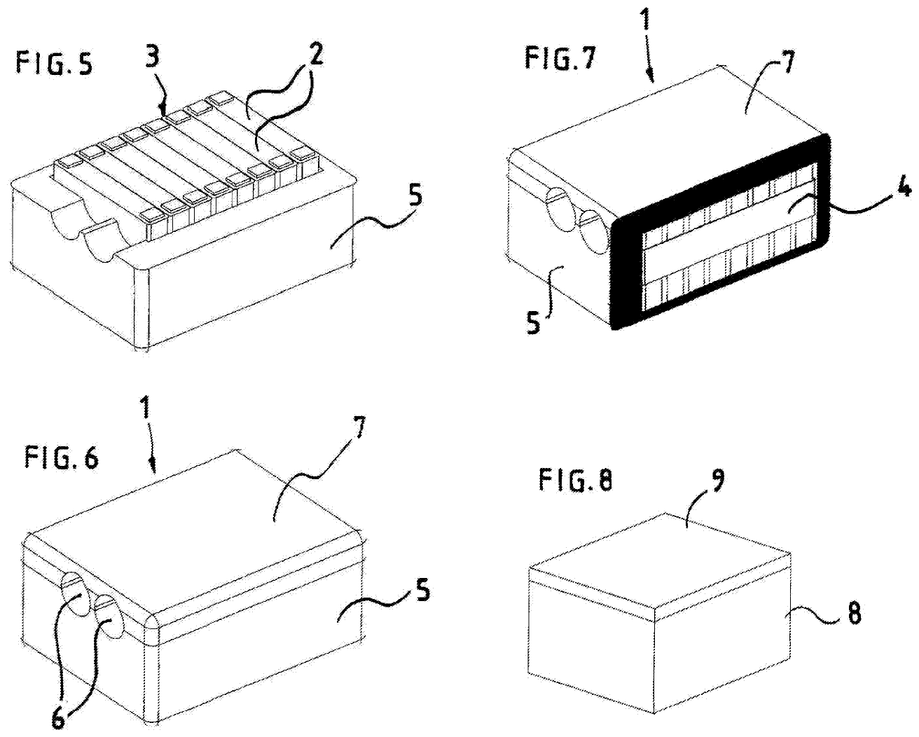

FIG. 6 shows a perspective illustration of the battery housing shown in FIGS. 4 and 5 comprising a cover;

FIG. 7 shows a perspective illustration of the battery housing shown in FIG. 6 comprising a cover, wherein a side wall of the battery housing is cut away in order to show the battery cell structure received in the battery housing;

FIG. 8 shows a housing casing including cover for receiving the battery cell structure that is to be provided with a battery housing;

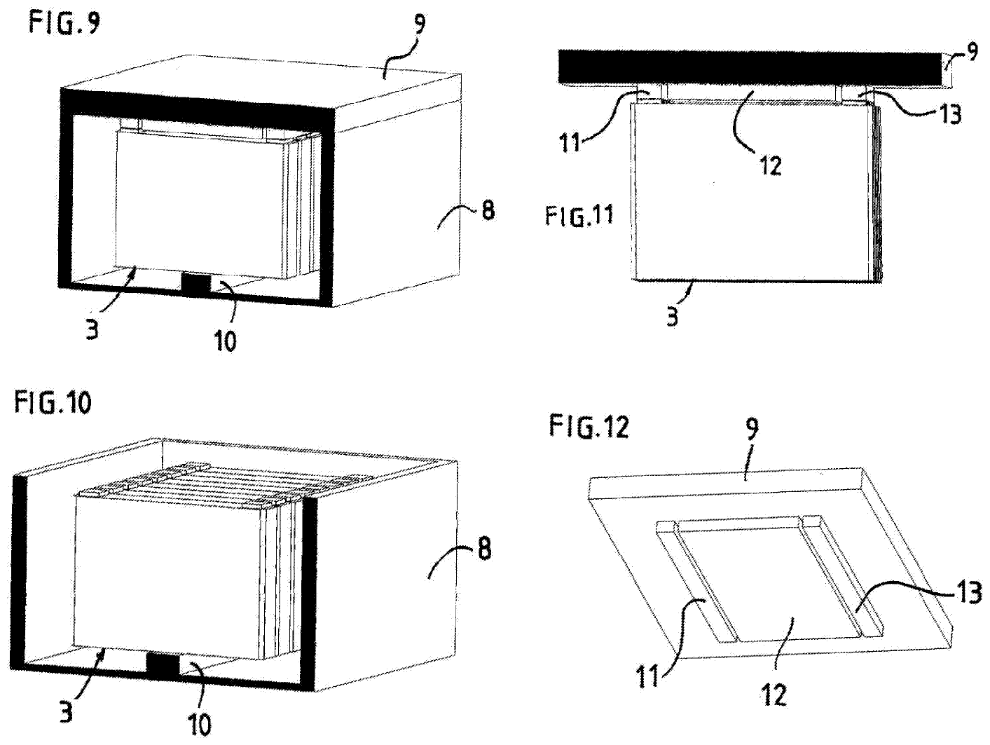

FIG. 9 shows a perspective illustration of the battery cell structure received in the housing casing shown in FIG. 8;

FIG. 10 shows an illustration corresponding to FIG. 9, wherein the cover of the housing casing is omitted;

FIG. 11 shows an illustration of the battery cell structure comprising a cover assigned to the housing casing; and

FIG. 12 shows a perspective illustration of the cover shown in FIG. 11 that is assigned to the housing casing.

An electric battery 1 that will be described in more detail below on the basis of exemplary embodiments with reference to the drawing, for an electrically or partially electrically driven motor vehicle, for a movable or a stationary unit, has battery cells 2 that are shown in FIG. 1. The number of the battery cells 2 is arbitrary. Eight battery cells 2 are illustrated in FIG. 1 that belong to the embodiment of the electric battery 1 that will be described in more detail below.

The battery cells 2 are joined together to form a battery cell structure 3, as it is shown in FIG. 2.

It is important to point out that with respect to the shape of the battery cells 2, other prismatic cells than those shown in FIG. 2 are also possible, e.g. round cells or pouch cells.

In the illustrated exemplary embodiment, the battery cells 2 that are joined together to form the battery cell structure 3, are fastened to one another by a belt 4 surrounding the battery cell structure 3, as follows in particular from FIG. 3.

Instead of a fastening of the battery cell structure 3 by the belt 4, technical solutions are also possible, in e case of in which the solid battery cell structure 3 is realized by cell connectors that are not illustrated in the figures, or in the case of which a temporary fixing device is provided.

The battery cell structure 3 shown in FIGS. 2 and 3 is received in a battery housing 5, as it is shown in an exemplary manner in FIG. 4. The battery housing 5 is made of an expanded or foamed plastic. This expanded or foamed plastic, is similar to the known plastic styrofoam. The battery cell structure 3 received within the battery housing 5 is shown in FIG. 5. The poles of the battery cell structure 3 in the battery housing 5 take place by connecting passages 6 provided on the housing. Connection of further electrical interfaces, electronic interfaces, mechanical interfaces and/or thermal interfaces can thereby also extend through the battery housing 5 to the exterior. On its top side, the battery housing 5 can be closed by a cover 7, as it is shown in FIG. 6. The cover 7 is thereby made of the same expanded or foamed plastic, as the remaining battery housing 5.

Instead of the battery housing 5 or in addition to the battery housing 5, a holder can be provided that serves the purpose of receiving the battery cells 2 as well as further battery components, such as sensor parts, etc. A holder of this type that is not shown in the figures, can also be made of an expanded or foamed plastic.

The battery housing 5, to which the cover 7 can belong, and this holder, insofar as the above-mentioned holder is provided, can be of multi-piece construction.

FIG. 7 shows the electric battery shown in FIG. 6, whereby a side wall is omitted in order to show how the battery cell structure including the belt 4 are received by the battery housing 5 and the cover 7.

The battery housing 5 can have further passages that are not shown in the figures that can be formed as cooling, stiffening and/or reinforcing passages.

In the case of a further embodiment of the electric battery according to the invention, a production process is provided, in the case of in which, e.g., the housing casing 8 shown in FIG. 8 is used, to which a cover casing 9 belongs. The battery cell structure 3 is introduced into the assembly of housing casing 8 and cover casing 9.

In the case of the embodiment shown in FIGS. 9 and 10, the battery cell structure 3 rests on a carrier 10 that belongs to the housing casing 8.

The cover casing 9 shown in FIG. 12 has casing parts 11, 12, 13 that protrude in the direction of the battery cell structure 3 and that extend between the actual cover casing 9 and the top side of the battery cell structure 3, as follows best from FIG. 11. The plastic is introduced into the intermediate space between the housing casing 8 and the cover casing 9 on the one hand, and the battery cell structure 3 on the other hand, is foamed and cured. It goes without saying that further structural parts can be provided before the introduction and foaming of the plastic, by which the passages, hollow spaces, etc. that are required for the electric battery 1, can be formed.

It goes without saying that the fixation of the battery cell structure 3 in the assembly shown in FIGS. 9 and 10 can also take place by the belt 4, but can also be realized differently.

On its outer surface, the battery housing 5 of the electric battery 1 can be designed arbitrarily. On its outer side, it can have shapes, by which a plurality of electric batteries 1 of this type can be joined together and stacked. A latching of the electric batteries 1 to their battery housings 5 is also conceivable.

The foamed plastic forming the battery housing 5 as well as optionally the cover 7 can have a high gas content. The plastic of the battery housing 5 furthermore contains a flame-retardant or self-extinguishing material. Reservoirs or cavities that are not illustrated in the figures and in which extinguishing substances, such as PyroBubbles, are stored, can be formed within the battery housing 5.

The battery housing 5 and/or the battery cell structure 3 can be surrounded by a safety shell that is not illustrated in the figures. Safety elements can furthermore be introduced into one or several cavities that are formed by the battery housing 5 or by the battery cell structure 3.

A design of the electric battery 1 according to the invention is generally also possible in which the battery cell structure 3 of the electric battery 1 is inside the motor vehicle or the other unit, at the installation site and is provided there with the battery cell housing 5, wherein the battery cell housing 5 is realized by introduction, foaming, and curing of the plastic.

1. An electric battery for an electrically or partially electrically driven motor vehicle or for a movable or stationary unit, the battery comprising:
a battery housing and
a plurality of battery cells therein, the battery housing being made of an expanded or foamed plastic.

2. The electric battery according to claim 1, wherein the battery cells are formed as round cell, prismatic cell, or pouch cell.

3. The electric battery according to claim 1, wherein the battery housing and/or a holder for the battery cells and further battery components, are made of the expanded or foamed plastic.

4. The electric battery according to claim 1, wherein the battery housing and/or the holder are of multi-piece construction.

5. The electric battery according to claim 1, wherein the battery housing has a cover.

6. The electric battery according to claim 1, wherein the plus and minus poles extend through the battery housing to the exterior.

7. The electric battery according to claim 6, wherein further electrical interfaces, electronic interfaces, mechanical interfaces and/or thermal interfaces extend through the battery housing to the exterior.

8. The electric battery according to claim 1, wherein the battery housing is made of plastic that is foamed onto a battery cell structure formed of the plurality of the battery cells of the electric battery, and that is cured there.

9. The electric battery according to claim 8, wherein the battery cells are joined together by a belt surrounding the battery cell structure.

10. The electric battery according to claim 8, wherein the battery cells are joined together to form the battery cell structure by electric cell connectors that serve for electrical connection to each other.

11. The electric battery according to claim 8, wherein the battery cell structure can be secured by a temporary fixing device.

12. The electric battery according to claim 1, wherein the battery housing has passages that are formed as cooling, stiffening and/or reinforcing passages.

13. The electric battery according to claim 1, wherein the battery housing has shapes formed on its outer side, by which a plurality of electric batteries of this type or battery housings, can be joined together or stacked.

14. The electric battery according to claim 1, wherein the battery housing has latching means on its outer side that latches a plurality of electric batteries of this type or battery housings with or to one another.

15. The electric battery according to claim 1, wherein the foamed plastic of the battery housing has a high gas content.

16. The electric battery according to claim 1, wherein the foamed plastic of the battery housing contains a flame-retardant self-extinguishing material.

17. The electric battery according to claim 1, wherein the battery housing has a reservoir or a cavity, in which extinguishing substances can be stored.

18. The electric battery according to claim 1, wherein the battery housing or the battery cell structure is surrounded by a safety shell and/or safety elements are introduced into one or several cavities that are formed by the battery housing or battery cell structure.

19. The electric battery according to claim 1, wherein the battery housing can be designed arbitrarily with respect to its geometry, outer surface, and dimensions.

20. A method for making and assembling an electric battery for an electrically or partially electrically driven motor vehicle, movable or stationary unit, preferably according to claim 1, wherein a plurality of battery cells is in a battery housing, characterized in that the battery housing is made of plastic and foamed onto a battery cell structure and is cured there.

21. The method according to claim 20, further comprising the step of:
fixing the battery cell structure by a belt that surrounds the battery cell structure during the foaming and curing of the battery cell housing.

22. The method according to claim 20, wherein further comprising the step of:
fixing the battery cell structure by electric cell connectors during the foaming and curing of the battery housing.

23. The method according to claim 20, further comprising the step of:
fixing the battery cell structure by a temporary fixing device during the foaming and curing of the battery housing.

24. The method according to claim 20, wherein the battery cell structure is used in an installation space of the motor vehicle or unit, and is provided with the battery housing.
